(19) United States
(12) Patent Application Publication
(10) Pub. No.: US 2011/0111230 A1
(43) Pub. Date: May 12, 2011

(54) COMPOSITE CERAMIC POWDER, PROCESS OF PRODUCING THE SAME, AND SOLID-OXIDE FUEL CELL

(75) Inventors: Toru Kinoshita, Tokyo (JP); Kazuyoshi Sato, Osaka (JP); Hiroya Abe, Osaka (JP); Makio Naito, Osaka (JP)

(73) Assignee: Sumitomo Osaka Cement Co., Ltd., Chiyoda-ku (JP)

(21) Appl. No.: 13/000,957

(22) PCT Filed: Jun. 26, 2009
(86) PCT No.: PCT/JP2009/061744

§ 371 Date: Dec. 22, 2010

(30) Foreign Application Priority Data
Jun. 27, 2008 (JP) 2008-168633
Dec. 10, 2008 (JP) 2008-314958

(51) Int. Cl. C04B 35/48; B82Y 30/00

(52) U.S. Cl. 428/402; 501/134; 501/135; 977/773

(57) ABSTRACT

A composite ceramic powder, which is excellent in uniform distribution at a nanometer level, composition controllability, and generation of oxygen ions or electron conductivity, a process of producing the composite ceramic powder, and a solid-oxide fuel cell, are provided. The composite ceramic powder includes oxide expressed by A₁₋ₓBₓC_{1-y}D_{y}O₃ (where A represents one or two elements selected from the group consisting of La and Sm; B represents one or two or more elements selected from the group consisting of Sr, Ca, and Ba; C represents one or two elements selected from the group consisting of Co and Mn; D represents one or two elements selected from the group consisting of Fe and Ni; and x and y satisfy 0.1≦x≦0.5 and 0≦y≦0.3) or nickel oxide and zirconia. Here, a neutralized precipitate is produced by adding a zirconia acidic dispersion containing zirconia particles formed of yttria-stabilized zirconia and nickel ions or ions of one or two or more elements selected from the group consisting of elements A, B, C, and D included in A₁₋ₓBₓC_{1-y}D_{y}O₃ to an alkali solution, and the neutralized precipitate is heated at a temperature equal to or higher than 200° C.

### TECHNICAL FIELD

The present invention relates to a composite ceramic powder, a process of producing the composite ceramic powder, and a solid-oxide fuel cell (SOFC), and more particularly, to a composite ceramic powder containing zirconia particles and perovskite type oxide particles or nickel oxide particles and having excellent uniform distribution and composition controllability of particles, a process of producing the composite ceramic powder, and a solid-oxide fuel cell using the composite ceramic powder as an electrode material.

Priority is claimed on Japanese Patent Application No. 2008-168633, filed Jun. 27, 2008, and Japanese Patent Application No. 2008-314958, field Dec. 10, 2008, the content of which is incorporated herein by reference.

### BACKGROUND ART

Hitherto, a mechanical mixing method of agitating and mixing plural types of oxide powders while pulverizing the powders using a pulverizer such as a ball mill and an automatic mortar to form a composite ceramic powder has generally been used as a method of producing a composite ceramic powder containing plural types of oxides. A mechanochemical mechanical mixing method including a mechanochemical technique of promoting the bonding between particles by thermal action has also been used.

However, the composite ceramic powder acquired by the method has a problem in that primary particles of plural types of oxides aggregate to form an irregularly-mixed composite powder or primary particles of each type of oxides aggregate to form a coarse composite powder. Therefore, when such a composite powder is used as a catalyst or an electrode of a fuel cell, the characteristics cannot be satisfactorily exhibited.

Therefore, as a method of producing such a composite ceramic powder for solving the above-mentioned problems, a so-called co-precipitation and burning method of adding an alkali solution to a solution containing plural types of metal ions constituting the composite ceramic powder, for example, La ions, Sr ions, Mn ions, Zr ions, and Y ions in a powder for an air electrode material of a solid-oxide fuel cell, generating a neutralized precipitate, heating the neutralized precipitate to produce oxide and to obtain the composite ceramic powder has been known (PATENT DOCUMENTS 1 and 2).

In an air electrode of a solid-oxide fuel cell, study has been made of the fact that the deterioration of the air electrode over time is prevented by burning a part of a raw powder of the composite ceramic particles and controlling the particle diameter (PATENT DOCUMENT 3).

On the other hand, as the method of producing a composite ceramic powder for a fuel electrode of a solid-oxide fuel cell, a method of immersing an oxide powder of oxygen ion conductivity formed of yttria-stabilized zirconia (YSZ) or samaria-doped ceria in a solution containing nickel ions or cobalt ions, drying the resultant oxide powder, heating the resultant oxide powder to hold nickel oxide or cobalt oxide on the surface of the oxide powder of oxygen ion conductivity, and additionally mixing a nickel or cobalt oxide powder into the resultant oxide powder to obtain a raw powder has been proposed (PATENT DOCUMENT 4).

A mist pyrolysis method has been known as a method providing the excellent uniform distribution or composition controllability of oxide. For example, a method of misting a solution containing yttria-stabilized zirconia particles and nickel acetate, drying the mist, and then heating the resultant up to the pyrolysis temperature of nickel acetate or higher to obtain a composite powder in which yttria-stabilized zirconia particle groups are eccentrically located on the surfaces of nickel oxide particle groups has been proposed (PATENT DOCUMENT 5).

### CITATION LIST

### Patent Literature

[PATENT DOCUMENT 1] Japanese Patent Application Laid-open No. 2000-44245
[PATENT DOCUMENT 2] Japanese Patent Application Laid-open No. 9-86932
[PATENT DOCUMENT 3] Japanese Patent Application Laid-open No. 2006-40822
[PATENT DOCUMENT 4] Japanese Patent No. 3565696
[PATENT DOCUMENT 5] Japanese Patent No. 3193294

### SUMMARY OF INVENTION

### Technical Problem

However, in the co-precipitation and burning method, since the combination state of metal ions in the precipitate varies depending on the co-precipitation conditions, there is a problem in that the production state of ceramics resulting from the heat treatment of the precipitate varies and thus it is difficult to make the characteristics of the obtained composite ceramic particles even.

When it is intended to control the particle diameter of the raw powder of the composite ceramic particles, the particle diameter is controlled at a micrometer level.

In the mist pyrolysis method, the uniform distribution or the composition controllability of plural types of oxides is improved, but the particle diameter of the primary particles of oxides in the acquired composite particles is great. Accordingly, when these coarse composite particles are used as a catalyst or an electrode of a fuel cell, there is a problem in that satisfactory characteristics cannot be obtained.

Here, in the field of solid-oxide fuel cells, it is said that the respective electrodes serve as reaction catalysts and a three-phase interface serves as a reaction field.

Three phases in an air electrode of a solid-oxide fuel cell include ceramic particles having oxygen ion conductivity, ceramic particles forming the electrodes, and gas such as air. In a system of A₁₋ₓBₓC_{1-y}D_{y}O₃ (where A represents one or two elements selected from the group consisting of La and Sm, B represents one or two or more elements selected from the group consisting of Sr, Ca, and Ba, C represents one or two elements selected from the group consisting of Co and Mn, D represents one or two elements selected from the group consisting of Fe and Ni, and x and y satisfy 0.1≦x≦0.5 and 0≦y≦0.3, respectively)-yttria-stabilized zirconia (A₁₋ₓBₓC_{1-y}D_{y}O₃—YSZ) (air electrode)/yttria-stabilized zirconia (electrolyte), a face in which A₁₋ₓBₓC_{1-y}D_{y}O₃, yttria-stabilized zirconia, and a gas such as air all come in contact with one another is the three-phase interface. Therefore, in order to improve the output characteristic of the solid-oxide fuel cell, it is necessary to increase the number of oxygen ions through the use of an enlargement of the three-phase interface. Since the performance depends on the size of the three-phase interface, it is necessary to satisfactorily reduce the size of the ceramic particles. As a result, there is a need for new composite ceramic particles which can be reduced in size and which are uniformly distributed at a nanometer level.

To solve the above-mentioned problems, a first goal of the invention is to provide a composite ceramic powder, which is excellent in the uniform distribution at a nanometer level and the composition controllability of plural types of oxide particles, has a lot of three-phase interfaces, and is excellent in the generation of oxygen ions, a method of producing the composite ceramic powder, and a solid-oxide fuel cell.

Three phases in a fuel electrode of a solid-oxide fuel cell include ceramic particles having oxygen ion conductivity, ceramic particles forming the electrodes, and a fuel gas such as hydrogen. In a system of nickel-yttria-stabilized zirconia (Ni—YSZ) (fuel electrode)/yttria-stabilized zirconia (electrolyte), a face in which nickel (Ni), yttria-stabilized zirconia, and fuel gas all come in contact with one another is the three-phase interface. Therefore, in order to improve the output characteristic of the solid-oxide fuel cell, it is necessary to increase the number of electrons through the use of an enlargement of the three-phase interface of the fuel electrode and to efficiently supply the generated electrons to an external circuit.

Therefore, there is a need for a composite ceramic powder which is uniform in particle diameters of plural types of oxide particles, is excellent in the uniform distribution or the composition controllability, and has a larger number of three-phase interfaces, that is, a composite ceramic powder with a smaller diameter of primary particles, but it is very difficult to implement such a composite ceramic powder.

To solve the above-mentioned problems, a second goal of the invention is to provide a composite ceramic powder, which is excellent in the uniform distribution and the composition controllability of plural types of oxide particles, has a lot of three-phase interfaces, and is excellent in the generation of electrons and electron conductivity, a process of producing the composite ceramic powder, and a solid-oxide fuel cell.

### Solution to Problem

The inventors were dedicated to accomplishing the above-mentioned goals and found that when a composite ceramic powder including oxide expressed by A₁₋ₓBₓC_{1-y}D_{y}O₃ (where A represents one or two elements selected from the group consisting of La and Sm, B represents one or two or more elements selected from the group consisting of Sr, Ca, and Ba, C represents one or two elements selected from the group consisting of Co and Mn, D represents one or two elements selected from the group consisting of Fe and Ni, and x and y satisfy 0.1≦x≦0.5 and 0≦y≦0.3, respectively) and zirconia is produced as the means for accomplishing the first goal, by adding a zirconia acidic dispersion containing zirconia particles formed of yttria-stabilized zirconia and ions of one or two or more elements selected from the group consisting of elements A, B, C, and D included in A₁₋ₓBₓC_{1-y}D_{y}O₃ to an alkali solution to produce a neutralized precipitate and heating the neutralized precipitate at a temperature equal to or higher than 200° C., it is possible to easily obtain the composite ceramic powder which is excellent in uniform distribution at a nanometer level and composition controllability of a plural types of oxide particles, which has a lot of three-phase interfaces, and which is excellent in the generation of oxygen ions. As a result, a first embodiment of the invention is made.

That is, a first embodiment of the invention provides a composite ceramic powder including oxide expressed by A₁₋ₓBₓC_{1-y}D_{y}O₃ (where A represents one or two elements selected from the group consisting of La and Sm; B represents one or two or more elements selected from the group consisting of Sr, Ca, and Ba; C represents one or two elements selected from the group consisting of Co and Mn; D represents one or two elements selected from the group consisting of Fe and Ni; and x and y satisfy 0.1≦x≦0.5 and 0≦y≦0.3, respectively) and zirconia, wherein the composite ceramic powder is produced by heating a neutralized precipitate which is obtained by adding a zirconia acidic dispersion containing zirconia particles formed of yttria-stabilized zirconia and ions of one or two or more elements selected from the group consisting of elements A, B, C, and D included in A₁₋ₓBₓC_{1-y}D_{y}O₃ to an alkali solution.

Preferably, a dispersion average particle diameter of the zirconia particles in the zirconia acidic dispersion is equal to or less than 20 nm.

The first embodiment of the invention also provides a process of producing a composite ceramic powder including oxide expressed by A₁₋ₓBₓC_{1-y}D_{y}O₃ (where A represents one or two elements selected from the group consisting of La and Sm; B represents one or two or more elements selected from the group consisting of Sr, Ca, and Ba; C represents one or two elements selected from the group consisting of Co and Mn; D represents one or two elements selected from the group consisting of Fe and Ni; and x and y satisfy 0.1≦x≦0.5 and 0≦y≦0.3, respectively) and zirconia, wherein the process includes steps of producing a neutralized precipitate by adding a zirconia acidic dispersion containing zirconia particles formed of yttria-stabilized zirconia and ions of one or two or more elements selected from the group consisting of elements A, B, C, and D included in A₁₋ₓBₓC_{1-y}D_{y}O₃ to an alkali solution and heating the neutralized precipitate at a temperature equal to or higher than 200° C. to produce a composite powder containing the oxide expressed by A₁₋ₓBₓC_{1-y}D_{y}O₃ and zirconia.

Preferably, a dispersion average particle diameter of the zirconia particles in the zirconia acidic dispersion is equal to or less than 20 nm.

It is also preferable that a ratio (M:Z) of the percentage by mass (M) of the ions of the one or two or more elements selected from the group consisting of elements A, B, C, and D in the zirconia acidic dispersion in terms of oxide and the percentage by mass (Z) of the zirconia particles is in the range of M:Z=90:10 to 10:90.

The first embodiment of the invention also provides a solid-oxide fuel cell using the composite ceramic powder according to the first embodiment of the invention as an electrode material.

The inventors were dedicated to accomplishing the above-mentioned goals and also found that when as a means for accomplishing the second goal, a neutralized precipitate is produced by adding a zirconia acidic dispersion containing zirconia particles formed of yttria-stabilized zirconia and nickel ions to an alkali solution and the neutralized precipitate is heated, it is possible to easily obtain the composite ceramic powder which is excellent in uniform distribution and composition controllability of particles, which has a lot of three-phase interfaces, and which is excellent in generation of electrons and electron conductivity. As a result, a second embodiment of the invention is made.

That is, a second embodiment of the invention provides a composite ceramic powder including nickel oxide and zirconia, wherein the composite ceramic powder is produced by heating a neutralized precipitate which is obtained by adding a zirconia acidic dispersion containing zirconia particles formed of yttria-stabilized zirconia and nickel ions to an alkali solution.

Preferably, a dispersion average particle diameter of the zirconia particles in the zirconia acidic dispersion is equal to or less than 20 nm.

The second embodiment of the invention also provides a process of producing a composite ceramic powder, wherein the process includes steps of producing a neutralized precipitate by adding a zirconia acidic dispersion containing zirconia particles formed of yttria-stabilized zirconia and nickel ions to an alkali solution and heating the neutralized precipitate at a temperature equal to or higher than 200° C. to produce a composite powder containing nickel oxide and zirconia.

Preferably, a dispersion average particle diameter of the zirconia particles in the zirconia acidic dispersion is equal to or less than 20 nm.

It is also preferable that a ratio (M:Z) of the percentage by mole (M) of the nickel ions in the zirconia acidic dispersion in terms of oxide and the percentage by mole (Z) of the zirconia particles is in the range of M:Z=90:10 to 10:90.

The second embodiment of the invention also provides a solid-oxide fuel cell using the composite ceramic powder according to the second embodiment of the invention as an electrode material.

The invention also provides a solid-oxide fuel cell using the composite ceramic powder according to the first embodiment of the invention as a material of an air electrode and using the composite ceramic powder according to the second embodiment of the invention as a material for a fuel electrode.

### Advantageous Effects of Invention

In the composite ceramic powder according to the first embodiment of the invention, since the neutralized precipitate obtained by adding a zirconia acidic dispersion containing zirconia particles formed of yttria-stabilized zirconia and ions of one or two or more elements selected from the group consisting of elements A, B, C, and D included in A₁₋ₓBₓC_{1-y}D_{y}O₃ to an alkali solution is heated, it is possible to improve the uniform distribution at a nanometer level of the powder formed of plural types of oxide particles and to improve the composition controllability of the particles. Therefore, it is possible to provide a composite ceramic powder which is excellent in the uniform distribution at a nanometer level and the composition controllability of the plural types of oxide particles, which has a lot of three-phase interfaces, and which is excellent in the generation of oxygen ions.

In the process of producing a composite ceramic powder according to the first embodiment of the invention, since a neutralized precipitate is produced by adding a zirconia acidic dispersion containing zirconia particles formed of yttria-stabilized zirconia and ions of one or two or more elements selected from the group consisting of elements A, B, C, and D included in A₁₋ₓBₓC_{1-y}D_{y}O₃ to an alkali solution and the neutralized precipitate is heated at a temperature equal to or higher than 200° C., it is possible to easily and cheaply produce a composite powder containing the oxide expressed by A₁₋ₓBₓC_{1-y}D_{y}O₃ and zirconia.

In the solid-oxide fuel cell according to the first embodiment of the invention, since the composite ceramic powder according to the first embodiment of the invention is used as the electrode material, it is possible to efficiently perform an ionization reaction of the electrons supplied from an external circuit with oxygen gas. Therefore, it is possible to increase the amount of oxygen to be ionized and to efficiently supply the generated oxygen ions to an electrolyte. As a result, it is possible to improve the output characteristic of the fuel cell.

In the composite ceramic powder according to the second embodiment of the invention, since the neutralized precipitate obtained by adding a zirconia acidic dispersion containing zirconia particles formed of yttria-stabilized zirconia and nickel ions to an alkali solution is heated, it is possible to improve the uniform distribution of particles in the powder formed of plural types of oxide particles and to improve the composition controllability of the particles. Therefore, it is possible to provide a composite ceramic powder which is excellent in the uniform distribution and the composition controllability of the plural types of oxide particles, which has a lot of three-phase interfaces, and which is excellent in the generation of electrons and electron conductivity.

In the process of producing a composite ceramic powder according to the second embodiment of the invention, since a neutralized precipitate is produced by adding a zirconia acidic dispersion containing zirconia particles formed of yttria-stabilized zirconia and nickel ions to an alkali solution and the neutralized precipitate is heated at a temperature equal to or higher than 200° C., it is possible to easily and cheaply produce a composite ceramic powder containing nickel oxide and zirconia.

In the solid-oxide fuel cell according to the second embodiment of the invention, since the composite ceramic powder according to the second embodiment of the invention is used as the electrode material, it is possible to increase the number of electrons to be generated. As a result, it is possible to efficiently supply the electrons to an external circuit and to improve the output characteristic.

### BRIEF DESCRIPTION OF DRAWINGS

FIG. 1 is a diagram schematically illustrating an electrochemical characteristic tester used to test electrodes of a solid-oxide fuel cell according to an embodiment of the invention.

FIG. 2 is a scanning transmission electron microscopy image of Composite Powder A-1 according to Example 1 of the invention.

FIG. 3 is a transmission electron microscopy image of Composite Powder A-1 according to Example 1 of the invention.

FIG. 4 is a transmission electron microscopy image of nickel oxide-yttria-stabilized zirconia composite particles according to Example 5 of the invention.

### DESCRIPTION OF EMBODIMENTS

Exemplary embodiments for putting a composite ceramic powder, a process of producing the composite ceramic powder, and a solid-oxide fuel cell according to the invention into practice will be described below.

The exemplary embodiments are intended to specifically describe the invention to facilitate the understanding thereof, and do not limit the invention as long as no particular restriction is set.

### First Embodiment

### Composite Ceramic Powder

A composite ceramic powder according to a first embodiment of the invention is a composite ceramic powder including oxide expressed by A₁₋ₓBₓC_{1-y}D_{y}O₃ (where A represents one or two elements selected from the group consisting of La and Sm; B represents one or two or more elements selected from the group consisting of Sr, Ca, and Ba; C represents one or two elements selected from the group consisting of Co and Mn; D represents one or two elements selected from the group consisting of Fe and Ni; and x and y satisfy 0.1≦x≦0.5 and 0≦y≦0.3, respectively) and zirconia. Here, the composite ceramic powder is obtained by heating a neutralized precipitate according to the first embodiment which is obtained by adding a zirconia acidic dispersion according to the first embodiment containing zirconia particles formed of yttria-stabilized zirconia and ions of one or two or more elements selected from the group consisting of elements A, B, C, and D included in A₁₋ₓBₓC_{1-y}D_{y}O₃ to an alkali solution.

Preferably, a dispersion average particle diameter of the zirconia particles in the zirconia acidic dispersion according to the first embodiment is equal to or less than 20 nm.

The composite ceramic powder according to the first embodiment is produced by adding a zirconia acidic dispersion containing zirconia particles formed of yttria-stabilized zirconia and ions of one or two or more elements selected from the group consisting of elements A, B, C, and D included in A₁₋ₓBₓC_{1-y}D_{y}O₃ to an alkali solution to produce the neutralized precipitate and then heating the neutralized precipitate at a temperature equal to or higher than 200° C.

### Process of Producing Composite Ceramic Powder

A process of producing the composite ceramic powder according to the first embodiment of the invention will be described in detail below.

### “Production of Zirconia Acidic Dispersion”

Ions of one or two or more elements selected from elements A, B, C, and D included in A₁₋ₓBₓC_{1-y}D_{y}O₃ are added to the zirconia dispersion to produce the zirconia acidic dispersion according to the first embodiment.

Zirconia particles contained in the zirconia acidic dispersion according to the first embodiment are yttria-stabilized zirconia particles.

The yttria-stabilized zirconia particles can be produced by a hydrothermal synthesis method or a burning method and, for example, the following method can be suitably used (see Japanese Patent Application Laid-open No. 2006-16236).

This method is a method of neutralizing a metallic salt solution with a basic solution to produce metal oxide precursors and producing metal oxide nano-particles from the metal oxide precursors. The basic solution is added to the metallic salt solution to partially neutralize the metallic salt solution so as to satisfy Expression 1 and an inorganic salt is added to the partially-neutralized solution to produce a mixture solution, and the mixture solution is heated.

0.5<n<m Expression 1

Here, m represents the valence of metal ions or metal oxide ions in the metallic salt solution and n represents the mole ratio of a hydroxyl group in the basic solution.

An aqueous solution containing an yttrium (Y) salt and a zirconium (Zr) salt is used as the metallic salt solution.

Preferably, the dispersion average particle diameter of the zirconia particles formed of the yttria-stabilized zirconia is equal to or less than 20 nm.

When the dispersion average particle diameter is greater than 20 nm, non-uniform precipitates of the zirconia particles and one or two or more elements selected from elements A, B, C, and D included in A₁₋ₓBₓC_{1-y}D_{y}O₃ can be easily produced by the addition of an alkali solution in a subsequent process. As a result, there is a concern that a composite ceramic powder having a bad distribution and a non-uniform composition may be produced.

Here, the dispersion average particle diameter is a particle diameter corresponding to the maximum value in a particle size distribution when the particle size distribution of the dispersion is measured by optically measuring the dispersing speed of particles in the dispersion due to Brownian motion through the use of a dynamic light-scattering method.

Subsequently, an acid such as a hydrochloric acid, a nitric acid, and an acetic acid is added to the zirconia dispersion and pH (hydrogen ion concentration) of this dispersion is adjusted to 4 or less, whereby the zirconia acidic dispersion is obtained.

Here, pH is set to 4 or less so as not to produce any precipitate of hydroxide of A, B, C, and D when an aqueous solution containing chloride, nitrate, sulfate, and acetate of one or two or more elements selected from the group consisting of elements A, B, C, and D is added thereto in a subsequent process.

Then, the aqueous solution containing salts such as chloride, nitrate, sulfate, and acetate of one or two or more elements selected from elements A, B, C, and D included in A₁₋ₓBₓC_{1-y}D_{y}O₃ is added to the zirconia acidic dispersion to produce the zirconia acidic dispersion according to the first embodiment in which the zirconia particles formed of yttria-stabilized zirconia and ions of one or two or more elements selected from elements A, B, C, and D included in A₁₋ₓBₓC_{1-y}D_{y}O₃ coexist.

In the zirconia acidic dispersion according to the first embodiment, the ratio (M:Z) of the percentage by mass (M) of the nickel ions or the ions of the one or two or more elements selected from the group consisting of elements A, B, C, and D in the zirconia acidic dispersion in terms of oxide and the percentage by mass (Z) of the zirconia particles is preferably in the range of M:Z=90:10 to 10:90 and more preferably in the range of M:Z=80:20 to 20:80.

By setting the ratio (M:Z) to the above-mentioned range, it is possible to freely produce composite ceramic particles in which perovskite type oxide particles containing one or two or more elements selected from the group consisting of A, B, C, and D are combined into the zirconia particles formed of yttria-stabilized zirconia or composite ceramic particles in which the zirconia particles formed of yttria-stabilized zirconia are combined into perovskite type oxide particles containing one or two or more elements selected from the group consisting of A, B, C, and D.

When the ratio (M:Z) departs from the range, the exposure ratio of particles with a small content from the surfaces of the composite ceramic particles is markedly reduced, the number of three-phase interfaces is greatly reduced, and thus the electrical characteristics as an electrode for the solid-oxide fuel cell (SOFC) are greatly deteriorated, which is not preferable.

The total concentration of the zirconia particles formed of yttria-stabilized zirconia and the ions of one or two or more elements selected from the group consisting of A, B, C, and D in the zirconia acidic dispersion according to the first embodiment is not particularly limited. However, from the viewpoint of productivity and handling, the total amount of the zirconia particles and the ions of one or two or more elements selected from the group consisting of A, B, C, and D is preferably in the range of 0.5 mass % to 10 mass %.

### “Production of Neutralized Precipitate”

The neutralized precipitate according to the first embodiment is produced by adding the zirconia acidic dispersion according to the first embodiment to an alkali solution.

Examples of the alkali solution include aqueous solutions of sodium hydroxide (NaOH), potassium hydroxide (KOH), sodium carbonate (Na₂CO₃), potassium carbonate (K₂CO₃), sodium hydrogen carbonate (NaHCO₃), potassium hydrogen carbonate (KHCO₃), ammonium carbonate ((NH₄)₂CO₃), ammonium hydrogen carbonate (NH₄HCO₃), and aqueous ammonia (NH₄OH), and water-soluble organic amines.

The concentration in the alkali solution is not particularly limited, but is preferably in the range of 0.1 mol % to 5 mol % from the viewpoint of productivity or handling.

Regarding the amount of alkali in the alkali solution to which the zirconia acidic dispersion according to the first embodiment is added, the amount of the alkali solution is adjusted so that the pH of the solution after the neutralized precipitate is produced by adding the zirconia acidic dispersion thereto is equal to or higher than 6. When the pH of the solution is less than 6, that is, when the solution is acidic, the neutralization of the ions of one or two or more elements selected from the group consisting of A, B, C, and D is not sufficient and thus the uniformity of the composition of the resultant composite ceramic powder deteriorates.

The temperature of the solutions at the time of adding the zirconia acidic dispersion according to the first embodiment to the alkali solution is room temperature and is preferably in the range of 1° C. to 50° C.

### “Heat Treatment of Neutralized Precipitate”

Impurity ions such as alkali ions or halogen ions are removed from the neutralized precipitate according to the first embodiment by the use of a known filtration and cleaning device and then the resultant is dried by the use of a drier.

Then, by heating the resultant product at a temperature of 200° C. or higher, preferably at the highest holding temperature of 500° C. to 1000° C., in the atmosphere by the use of, for example, an electric furnace, the composite ceramic powder according to the first embodiment including the perovskite type oxide particles containing one or two or more elements selected from the group consisting of A, B, C, and D and the zirconia particles formed of yttria-stabilized zirconia is produced.

Here, the reason for limiting the highest holding temperature of the heat treatment to 200° C. or higher is as follows. That is, when the highest holding temperature is lower than 200° C., the production of oxide particles containing one or two or more elements selected from the group consisting of A, B, C, and D is not sufficient and it is thus not possible to freely control and produce the composite ceramic particles in which the oxide particles containing one or two or more elements selected from the group consisting of A, B, C, and D are combined into the zirconia particles formed of yttria-stabilized zirconia or the composite ceramic particles in which the zirconia particles formed of yttria-stabilized zirconia are combined into the oxide particles containing one or two or more elements selected from the group consisting of A, B, C, and D.

In this method, the dried product before the heat treatment is in the state where the zirconia particles formed of fine yttria-stabilized zirconia with a nanometer size and the oxide precursor particles containing one or two or more elements selected from the group consisting of A, B, C, and Dare uniformly mixed. The uniformly distributed zirconia particles serve to prevent the aggregation and the growth of the perovskite type oxide particles at the time of performing the heat treatment. Therefore, coarse perovskite type oxide particles are not produced in the composite ceramic powder due to the heat treatment and it is thus possible to produce the composite ceramic powder according to the first embodiment in which the zirconia particles formed of yttria-stabilized zirconia and the perovskite type oxide particles both have a small particle diameter.

### Solid-Oxide Fuel Cell

A solid-oxide fuel cell according to the first embodiment of the invention employs the composite ceramic powder according to the first embodiment as an electrode material. The electrode material can cause the electrons supplied from an external circuit and the oxygen gas to efficiently react with each other. Therefore, it is possible to increase the number of oxygen ions to be produced in the air electrode and thus to efficiently supply the produced oxygen ions to the electrolyte. As a result, it is possible to improve the output characteristic of the fuel cell.

Known methods can be used as a method of producing an air electrode of the solid-oxide fuel cell using the composite ceramic powder according to the first embodiment. An example thereof is a method of applying a paste, which is obtained by mixing a binder such as polyethyleneglycol and polyvinylbutyral with the composite ceramic powder, to the surface of a solid electrolyte substrate formed of yttria-stabilized zirconia or the like through the use of a printing method to form a film and then burning the resultant at a temperature of 700° C. to 1400° C. in an oxidizing atmosphere, for example, in the air.

Since the composite ceramic powder according to the first embodiment is composite particles in which the yttria-stabilized zirconia (YSZ) particles and the perovskite type oxide particles containing one or two or more elements selected from the group consisting of A, B, C, and D are dispersed at a nanometer level, it is possible to suppress the aggregation or growth of the perovskite type oxide particles at the temperature for generating power in the solid-oxide fuel cell. Therefore, it is possible to provide a solid-oxide fuel cell having an air electrode which has a lot of three-phase interfaces and which is excellent in generation of oxygen ions.

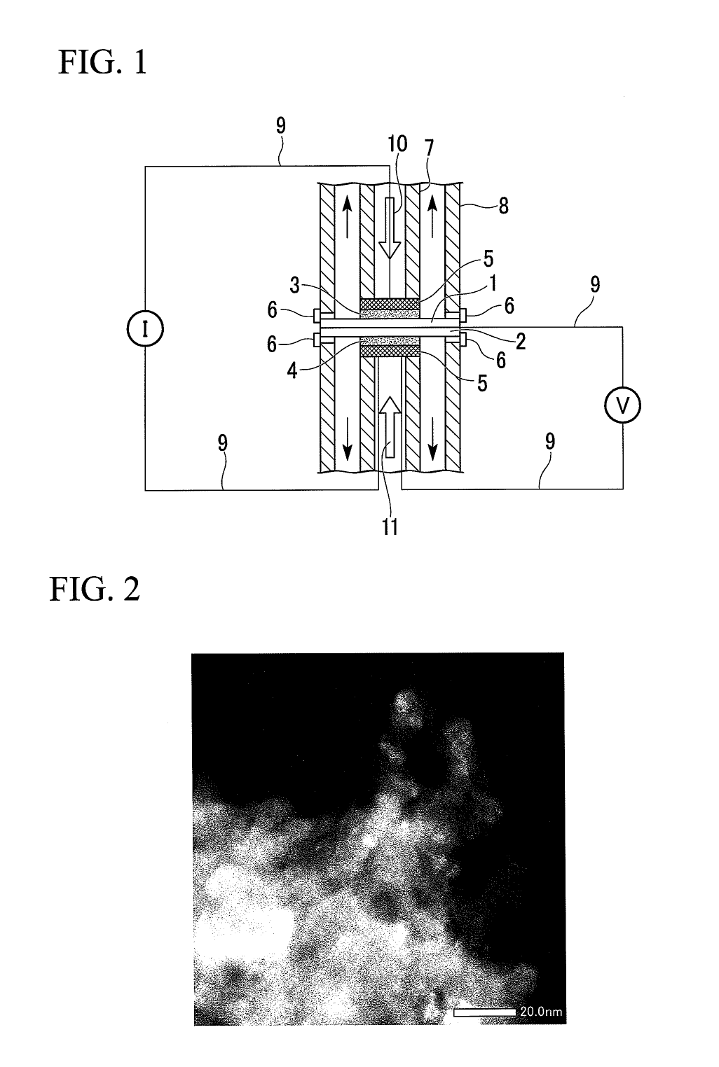

FIG. 1 is a diagram schematically illustrating an electrochemical characteristic tester, which is an apparatus for measuring electrical characteristics of electrodes of the solid-oxide fuel cell.

In the drawing, reference numeral 1 represents an electrolyte such as yttria-stabilized zirconia, reference numeral 2 represents a reference electrode formed of platinum (Pt), reference numeral 3 represents an air electrode formed on the top of the electrolyte 1 out of La_{0.8}Sr_{0.2}MnO₃ (LSM) or the like and produced using the composite ceramic powder according to the first embodiment, reference numeral 4 represents a fuel electrode formed on the bottom of the reference electrode 2 out of NiO-YSZ, CoO-YSZ, or the like, reference numeral 5 represents a platinum mesh disposed on the air electrode 3 and the fuel electrode 4, reference numeral 6 represents a glass seal, reference numerals 7 and 8 represent alumina tubes with different diameters disposed coaxially with each other, reference numeral 9 represents a platinum wire, reference numeral 10 represents dry air, and reference numeral 11 represents humidified hydrogen gas with a composition of 3% H₂O-97% H₂.

Here, at the time of measuring electrode reaction resistance of the air electrode 3 of the solid-oxide fuel cell, the air electrode 3 and the platinum mesh 5 are sequentially attached to the top surface of the electrolyte 1, the fuel electrode 4 and the platinum mesh 5 are sequentially attached to the bottom surface of the reference electrode 2, and AC impedance between the fuel electrode 4 and the reference electrode 2 in the temperature range of 600° C. to 800° C. is measured using the air electrode 3 as a counter electrode while supplying the dry air 10 to the air electrode 3 and supplying the humidified hydrogen gas 11 to the fuel electrode 4.

As described above, in the composite ceramic powder according to the first embodiment of the invention, it is possible to cause both the zirconia particles formed of yttria-stabilized zirconia and the perovskite type oxide particles containing one or two or more elements selected from the group consisting of A, B, C, and D to have a small particle diameter and thus to improve the uniform distribution of the particles and the composition controllability of the particles. Therefore, it is possible to provide a composite ceramic powder which is excellent in uniform distribution at a nanometer level and in composition controllability of plural types of oxide particles such as the zirconia particles formed of yttria-stabilized zirconia and the perovskite type oxide particles containing one or two or more elements selected from the group consisting of A, B, C, and D, in which the group has a lot of three-phase interfaces, and in which the group is excellent in generation of oxygen ions.

In the process of producing the composite ceramic powder according to the first embodiment of the invention, since a neutralized precipitate is produced by adding a zirconia acidic dispersion containing zirconia particles formed of yttria-stabilized zirconia and ions of one or two or more elements selected from the group consisting of elements A, B, C, and D included in A₁₋ₓBₓC_{1-y}D_{y}O₃ to an alkali solution and the neutralized precipitate is heated at a temperature equal to or higher than 200° C., it is possible to easily and cheaply produce a composite ceramic powder with a small particle diameter containing oxide expressed by A₁₋ₓBₓC_{1-y}D_{y}O₃ and zirconia formed of yttria-stabilized zirconia.

In the solid-oxide fuel cell according to the first embodiment of the invention, since the composite ceramic powder according to the first embodiment is used as the electrode material of the air electrode, it is possible to efficiently perform an ionization reaction of the electrons supplied from an external circuit with oxygen gas. Therefore, it is possible to increase the amount of oxygen generated in the air electrode, that is, the amount of oxygen to be ionized, and to efficiently supply the generated oxygen ions to an electrolyte. As a result, it is possible to improve the output characteristic of the fuel cell.

### Second Embodiment

### Composite Ceramic Powder

A composite ceramic powder according to a second embodiment of the invention is a composite ceramic powder including nickel oxide and zirconia. Here, the composite ceramic powder is obtained by heating a neutralized precipitate according to the second embodiment which is obtained by adding a zirconia acidic dispersion according to the second embodiment containing zirconia particles formed of yttria-stabilized zirconia and nickel ions to an alkali solution.

Preferably, the dispersion average particle diameter of the zirconia particles in the zirconia acidic dispersion according to the second embodiment is equal to or less than 20 nm.

The composite ceramic powder according to the second embodiment is produced by adding the zirconia acidic dispersion according to the second embodiment containing zirconia particles formed of yttria-stabilized zirconia and nickel ions to an alkali solution to produce the neutralized precipitate according to the second embodiment and then heating the neutralized precipitate according to the second embodiment at a temperature equal to or higher than 200° C.

### Process of Producing Composite Ceramic Powder

A process of producing the composite ceramic powder according to the second embodiment of the invention will be described in detail below.

### “Production of Zirconia Acidic Dispersion”

Nickel ions are added to the zirconia dispersion to produce the zirconia acidic dispersion according to the second embodiment in the same way as the first embodiment of the invention, except that the nickel ions are used instead of the ions of one or two or more elements selected from elements A, B, C, and D included in A₁₋ₓBₓC_{1-y}D_{y}O₃ according to the first embodiment of the invention.

### “Production of Neutralized Precipitate”

In the same way as the first embodiment of the invention, the zirconia acidic dispersion according to the second embodiment is added to the alkali solution to produce the neutralized precipitate according to the second embodiment.

### “Heat Treatment of Neutralized Precipitate”

Impurity ions such as alkali ions or halogen ions are removed from the neutralized precipitate according to the second embodiment by the use of a known filtration and cleaning device and then the resultant is dried by the use of a drier.

Then, by heating the resultant product at a temperature of 200° C. or higher, preferably at the highest holding temperature of 500° C. to 1000° C., in the atmosphere by the use of, for example, an electric furnace, the composite ceramic powder according to the second embodiment including the nickel oxide particles and the zirconia particles formed of yttria-stabilized zirconia is produced.

Here, the reason for limiting the highest holding temperature of the heat treatment to 200° C. or higher is as follows. That is, when the highest holding temperature is lower than 200° C., the production of the nickel oxide particles is not sufficient and it is thus not possible to freely control and produce the composite ceramic particles in which the nickel oxide particles are combined into the zirconia particles formed of yttria-stabilized zirconia or the composite ceramic particles in which the zirconia particles formed of yttria-stabilized zirconia are combined into the nickel oxide particles.

In this method, the dried product before the heat treatment is in the state where the zirconia particles formed of fine yttria-stabilized zirconia with a nanometer size and the nickel oxide precursor particles are uniformly mixed. The uniformly distributed zirconia particles serve to prevent the aggregation and the growth of the perovskite type oxide particles at the time of performing the heat treatment. Therefore, coarse nickel oxide particles are not produced in the composite ceramic powder due to the heat treatment and it is thus possible to produce the composite ceramic powder in which the zirconia particles formed of yttria-stabilized zirconia and the nickel oxide particles both have a small particle diameter.

### Solid-Oxide Fuel Cell

A solid-oxide fuel cell according to the second embodiment of the invention employs the composite ceramic powder according to the second embodiment as an electrode material. The electrode material can increase the number of electrons to be produced and thus to efficiently supply the electrons to an external circuit. As a result, it is possible to improve the output characteristic of the fuel cell.

Known methods can be used as a method of producing a fuel electrode of the solid-oxide fuel cell using the composite ceramic powder according to the second embodiment. An example thereof is a method of applying a paste, which is obtained by mixing a binder such as polyethyleneglycol and polyvinylbutyral with the composite ceramic powder, to the surface of a solid electrolyte substrate formed of yttria-stabilized zirconia or the like through the use of a printing method to form a film and then burning the resultant at a temperature of 1200° C. to 1500° C. in an atmosphere of air.

A composite ceramic powder according to the second embodiment can suppress the aggregation or growth of nickel particles even when a reduction-metallization process of nickel oxide is carried out in a reducing atmosphere at the time of generating power in the solid-oxide fuel cell. Therefore, it is possible to provide a solid-oxide fuel cell having a fuel electrode which has a lot of three-phase interfaces and which is excellent in electron conductivity.

FIG. 1 is a diagram schematically illustrating an electrochemical characteristic tester, which is an apparatus for measuring electrical characteristics of electrodes of the solid-oxide fuel cell.

In the drawing, reference numeral 1 represents an electrolyte such as yttria-stabilized zirconia, reference numeral 2 represents a reference electrode formed of platinum (Pt), reference numeral 3 represents an air electrode formed on the top of the electrolyte 1 out of La_{0.8}Sr_{0.2}MnO₃ (LSM) or the like and produced using the composite ceramic powder according to the first embodiment, reference numeral 4 represents a fuel electrode formed on the bottom of the reference electrode 2 out of nickel oxide-yttria-stabilized zirconia produced using the composite ceramic powder according to the second embodiment, reference numeral 5 represents a platinum mesh disposed on the air electrode 3 and the fuel electrode 4, reference numeral 6 represents a glass seal, reference numerals 7 and 8 represent alumina tubes with different diameters disposed coaxially with each other, reference numeral 9 represents a platinum wire, reference numeral 10 represents dry air, and reference numeral 11 represents humidified hydrogen gas with a composition of 3% H₂O-97% H₂.

Here, in order to measure electrode reaction resistance of the fuel electrode 4 of the solid-oxide fuel cell, the air electrode 3 and the platinum mesh 5 are sequentially attached to the top surface of the electrolyte 1, the fuel electrode 4 and the platinum mesh 5 are sequentially attached to the bottom surface of the reference electrode 2, and AC impedance between the fuel electrode 4 and the reference electrode 2 in the temperature range of 600° C. to 800° C. is measured using the air electrode 3 as a counter electrode while supplying the dry air 10 to the air electrode 3 and supplying the humidified hydrogen gas 11 to the fuel electrode 4.

As described above, in the composite ceramic powder according to the second embodiment of the invention, it is possible to cause both the zirconia particles formed of yttria-stabilized zirconia and the nickel oxide particles to have a small particle diameter and thus to improve the uniform distribution of the particles and the composition controllability of the particles. Therefore, it is possible to provide a composite ceramic powder which is excellent in uniform distribution and in composition controllability of plural types of oxide particles such as the zirconia particles formed of yttria-stabilized zirconia and the nickel oxide particles, which has a lot of three-phase interfaces, and which is excellent in generation of oxygen ions.

In the process of producing the composite ceramic powder according to the second embodiment of the invention, since a neutralized precipitate is produced by adding a zirconia acidic dispersion containing zirconia particles formed of yttria-stabilized zirconia and nickel ions to an alkali solution and the neutralized precipitate is heated at a temperature equal to or higher than 200° C., it is possible to easily and cheaply produce a composite ceramic powder with a small particle diameter containing nickel oxide particles and zirconia particles formed of yttria-stabilized zirconia.

In the solid-oxide fuel cell according to the second embodiment of the invention, since the composite ceramic powder according to the second embodiment of the invention is used as the electrode material, it is possible to increase the number of electrons to be generated in the fuel electrode. As a result, it is possible to efficiently supply the electrons to an external circuit and to improve the output characteristic.

### EXAMPLES

The invention will be specifically described below with reference to the use of examples and comparative examples, but the invention is not limited to the examples.

### Example 1

A metallic salt solution of La, Sr, and Mn, in which 62.81 g of lanthanum nitrate (La(NO₃)₃6H₂O), 7.68 g of strontium nitrate (Sr (NO₃)₂), and 52.04 g of manganese nitrate (Mn (NO₃)₂6H₂O) are dissolved in 1000 g of diluted nitric acid with a pH of 2.0 so as to have a composition of La_{0.8}Sr_{0.2}MnO₃, was added to 500 g of a 10 mol % yttria-stabilized zirconia (10YSZ) dispersion (with a solid concentration of 10YSZ of 8.4 mass % and pH of 3.95) with a dispersion average particle diameter of 7.5 nm and the resultant solution was agitated, whereby an acidic dispersion with a pH of 2.0 of 10 mol % yttria-stabilized zirconia (LSM-10YSZ) containing ions of La, Sr, and Mn was produced (Dispersion A-1).

Subsequently, 75.72 g of ammonium hydrogen carbonate (NH₄HCO₃) was dissolved in 3000 g of distilled water, whereby an aqueous solution of ammonium hydrogen carbonate (basic carbonate solution) was produced (Aqueous Solution B-1).

Then, Dispersion A-1 was dropped in Aqueous Solution B-1, whereby a neutralized precipitate was obtained. Here, aqueous ammonia of 25 mass % along with Dispersion A-1 was dropped in Aqueous Solution B-1 and the pH of Aqueous Solution B-1 was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated by the use of an electric furnace, whereby Composite Powder A-1 of La_{0.8}Sr_{0.2}MnO₃-yttria-stabilized zirconia (LSM-10YSZ) was obtained.

The masses of La, Sr, Mn, Y, and Zr in Composite Powder A-1 were measured by fluorescent X-ray analysis and the mass ratio of La_{0.8}Sr_{0.2}MnO₃ (LSM) and yttria-stabilized zirconia (YSZ) was calculated on the basis of the measurement result. As a result, the mass ratio (LSM:YSZ) was 50:50.

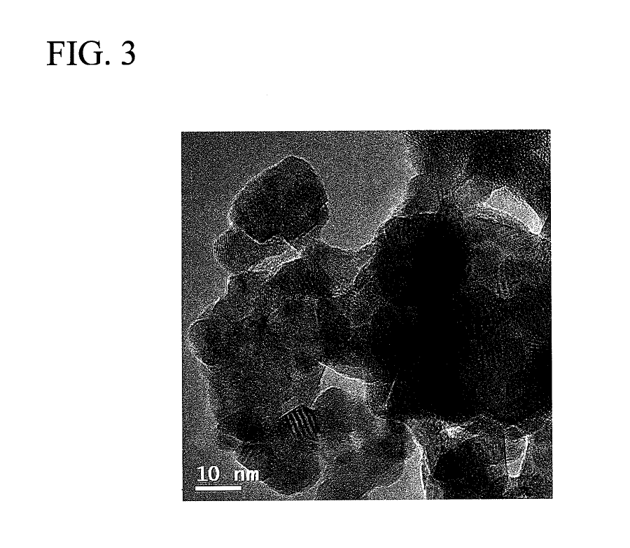

FIG. 2 is a scanning transmission electron microscopy (STEM) image of Composite Powder A-1 and FIG. 3 is a transmission electron microscopy (TEM) image of Composite Powder A-1.

From the drawings, it can be confirmed that the YSZ particles are combined into the LSM particles to form a body.

In order to evaluate the combination uniformity of Composite Powder A-1, crystallite diameters of LSM and YSZ of the composite powder were measured under two heating conditions of 6 hours at 600° C. and 6 hours at 800° C. The result is shown in Table 1.

Subsequently, 1.5 g of a mixture powder obtained by heating Composite Powder A-1 at 1000° C. for 6 hours was mixed with 0.5 g of polyethyleneglycol (with a molecular weight of 400) and 10 g of ethanol through the use of a ball mill, and the mixture solution was heated up to 80° C. to vaporize and remove ethanol, whereby Paste A-1 of La_{0.8}Sr_{0.2}MnO₃-yttria-stabilized zirconia (LSM-10YSZ) was obtained.

Then, 1.5 g of a nickel oxide (NiO) powder was mixed with 0.5 g of polyethyleneglycol (with a molecular weight of 400) and 10 g of ethanol through the use of a ball mill, and the mixture solution was heated up to 80° C. to vaporize and remove ethanol, whereby an NiO paste was produced.

Subsequently, the NiO paste was applied to an 8 mol % yttria-stabilized zirconia (8YSZ) substrate with a thickness of 300 μm through the use of a screen printing method and the resultant was then burned at 1200° C. for 2 hours, whereby a fuel electrode was formed on the 8YSZ substrate.

LSM-10YSZ Paste A-1 was applied to the surface of the 8YSZ substrate opposite to the surface on which the fuel electrode was formed through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the air electrode was measured by the use of the electrochemical characteristic tester shown in FIG. 1. Here, the electrode reaction resistance of the air electrode was evaluated by supplying dry air to the air electrode and the reference electrode and humidified hydrogen gas with a composition of 3% H₂O-97% H₂ to the fuel electrode at a flow rate of 50 mL/minute, and measuring the AC impedance between the reference electrode and the air electrode using the fuel electrode as a counter electrode. Two measurement temperatures of 700° C. and 800° C. were used and the measurement frequency was set to the range of 10 kHz to 0.1 Hz. The measurement results are shown in Table 1.

### Example 2

A metallic salt solution of La, Sr, and Mn, in which 146.56 g of lanthanum nitrate (La(NO₃)₃6H₂O), 17.91 g of strontium nitrate (Sr(NO₃)₂), and 121.43 g of manganese nitrate (Mn(NO₃)₂6H₂O) are dissolved in 1000 g of diluted nitric acid with a pH of 2.0 so as to have a composition of La_{0.8}Sr_{0.2}MnO₃, was added to 500 g of a 10 mol % yttria-stabilized zirconia (10YSZ) dispersion (with a solid concentration of 10YSZ of 8.4 mass % and pH of 3.95) with a dispersion average particle diameter of 7.5 nm and the resultant solution was agitated, whereby an acidic dispersion with a pH of 2.0 of 10 mol % yttria-stabilized zirconia (LSM-10YSZ) containing ions of La, Sr, and Mn was produced (Dispersion A-2).

Subsequently, similarly to Example 1, 167.7 g of ammonium hydrogen carbonate (NH₄HCO₃) was dissolved in 3000 g of distilled water, whereby an aqueous solution of ammonium hydrogen carbonate (basic carbonate solution) was produced (Aqueous Solution B-2).

Then, Dispersion A-2 was dropped in Aqueous Solution B-2, whereby a neutralized precipitate was obtained. Here, aqueous ammonia of 25 mass % along with Dispersion A-2 was dropped in Aqueous Solution B-2 and the pH of Aqueous Solution B-2 was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated by the use of an electric furnace, whereby Composite Powder A-2 of La_{0.8}Sr_{0.2}MnO₃-yttria-stabilized zirconia (LSM-10YSZ) was obtained.

The masses of La, Sr, Mn, Y, and Zr in Composite Powder A-2 were measured by fluorescent X-ray analysis and the mass ratio of La_{0.8}Sr_{0.2}MnO₃ (LSM) and yttria-stabilized zirconia (YSZ) was calculated on the basis of the measurement result. As a result, the mass ratio (LSM:YSZ) was 70:30.

In order to evaluate the combination uniformity of Composite Powder A-2, crystallite diameters of LSM and YSZ of the composite powder were measured under two heating conditions of 6 hours at 600° C. and 6 hours at 800° C. The result is shown in Table 1.

Subsequently, 1.5 g of a mixture powder obtained by heating Composite Powder A-2 at 1000° C. for 6 hours was mixed with 0.5 g of polyethyleneglycol (with a molecular weight of 400) and 10 g of ethanol through the use of a ball mill, and the mixture solution was heated up to 80° C. to vaporize and remove ethanol, whereby Paste A-2 of La_{0.8}Sr_{0.2}MnO₃-yttria-stabilized zirconia (LSM-10YSZ) was obtained.

Then, 1.5 g of a nickel oxide (NiO) powder was mixed with 0.5 g of polyethyleneglycol (with a molecular weight of 400) and 10 g of ethanol through the use of a ball mill, and the mixture solution was heated up to 80° C. to vaporize and remove ethanol, whereby an NiO paste was produced.

Subsequently, the NiO paste was applied to an 8 mol % yttria-stabilized zirconia (8YSZ) substrate with a thickness of 300 μm through the use of a screen printing method and the resultant was then burned at 1200° C. for 2 hours, whereby a fuel electrode was formed on the 8YSZ substrate.

LSM-10YSZ Paste A-2 was applied to the surface of the 8YSZ substrate opposite to the surface on which the fuel electrode was formed through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the air electrode was measured by the use of the electrochemical characteristic tester shown in FIG. 1. Here, the electrode reaction resistance of the air electrode was evaluated by supplying dry air to the air electrode and the reference electrode and humidified hydrogen gas with a composition of 3% H₂O-97% H₂ to the fuel electrode at a flow rate of 50 mL/minute, and measuring the AC impedance between the reference electrode and the air electrode using the fuel electrode as a counter electrode. Two measurement temperatures of 700° C. and 800° C. were used and the measurement frequency was set to be in the range of 10 kHz to 0.1 Hz. The measurement results are shown in Table 1.

### Example 3

A metallic salt solution of La, Sr, and Mn, in which 26.92 g of lanthanum nitrate (La(NO₃)₃6H₂O), 3.29 g of strontium nitrate (Sr(NO₃)₂), and 22.30 g of manganese nitrate (Mn(NO₃)₂6H₂O) are dissolved in 1000 g of diluted nitric acid with a pH of 2.0 so as to have a composition of La_{0.8}Sr_{0.2}MnO₃, was added to 500 g of 10 mol % yttria-stabilized zirconia (10YSZ) dispersion (with a solid concentration of 10YSZ of 8.4 mass % and pH of 3.95) with a dispersion average particle diameter of 7.5 nm and the resultant solution was agitated, whereby an acidic dispersion with a pH of 2.0 of 10 mol % yttria-stabilized zirconia (LSM-10YSZ) containing ions of La, Sr, and Mn was produced (Dispersion A-3).

Subsequently, similarly to Example 1, 32.45 g of ammonium hydrogen carbonate (NH₄HCO₃) was dissolved in 3000 g of distilled water, whereby an aqueous solution of ammonium hydrogen carbonate (basic carbonate solution) was produced (Aqueous Solution B-3).

Then, Dispersion A-3 was dropped in Aqueous Solution B-3, whereby a neutralized precipitate was obtained. Here, aqueous ammonia of 25 mass % along with Dispersion A-3 was dropped in Aqueous Solution B-3 and the pH of Aqueous Solution B-3 was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated by the use of an electric furnace, whereby Composite Powder A-3 of La_{0.8}Sr_{0.2}MnO₃-yttria-stabilized zirconia (LSM-10YSZ) was obtained.

The masses of La, Sr, Mn, Y, and Zr in Composite Powder A-3 were measured by fluorescent X-ray analysis and the mass ratio of La_{0.8}Sr_{0.2}MnO₃ (LSM) and yttria-stabilized zirconia (YSZ) was calculated on the basis of the measurement result. As a result, the mass ratio (LSM:YSZ) was 30:70.

In order to evaluate the combination uniformity of Composite Powder A-3, crystallite diameters of LSM and YSZ of the composite powder were measured under two heating conditions of 6 hours at 600° C. and 6 hours at 800° C. The results are shown in Table 1.

Subsequently, 1.5 g of a mixture powder obtained by heating Composite Powder A-3 at 1000° C. for 6 hours was mixed with 0.5 g of polyethyleneglycol (with a molecular weight of 400) and 10 g of ethanol through the use of a ball mill, and the mixture solution was heated up to 80° C. to vaporize and remove ethanol, whereby Paste A-3 of La_{0.8}Sr_{0.2}MnO₃-yttria-stabilized zirconia (LSM-10YSZ) was obtained.

Then, 1.5 g of a nickel oxide (NiO) powder was mixed with 0.5 g of polyethyleneglycol (with a molecular weight of 400) and 10 g of ethanol through the use of a ball mill, and the mixture solution was heated up to 80° C. to vaporize and remove ethanol, whereby a NiO paste was produced.

Subsequently, the NiO paste was applied to an 8 mol % yttria-stabilized zirconia (8YSZ) substrate with a thickness of 300 μm through the use of a screen printing method and the resultant was then burned at 1200° C. for 2 hours, whereby a fuel electrode was formed on the 8YSZ substrate.

LSM-10YSZ Paste A-3 was applied to the surface of the 8YSZ substrate opposite to the surface on which the fuel electrode was formed through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the air electrode was measured by the use of the electrochemical characteristic tester shown in FIG. 1. Here, the electrode reaction resistance of the air electrode was evaluated by supplying dry air to the air electrode and the reference electrode and humidified hydrogen gas with a composition of 3% H₂O-97% H₂ to the fuel electrode at a flow rate of 50 mL/minute, and measuring the AC impedance between the reference electrode and the air electrode using the fuel electrode as a counter electrode. Two measurement temperatures of 700° C. and 800° C. were used and the measurement frequency was set to the range of 10 kHz to 0.1 Hz. The measurement results are shown in Table 1.

### Example 4

A metallic salt solution of La, Sr, and Mn, in which 62.81 g of lanthanum nitrate (La(NO₃)₃6H₂O), 7.68 g of strontium nitrate (Sr (NO₃)₂), and 52.04 g of manganese nitrate (Mn(NO₃)₂6H₂O) are dissolved in 1000 g of diluted nitric acid with a pH of 2.0 so as to have a composition of La_{0.8}Sr_{0.2}MnO₃, was added to 500 g of 10 mol % yttria-stabilized zirconia (10YSZ) dispersion (with a solid concentration of 10YSZ of 8.4 mass % and a pH of 3.95) with a dispersion average particle diameter of 20 nm and the resultant solution was agitated, whereby an acidic dispersion with a pH of 2.0 of 10 mol % yttria-stabilized zirconia (LSM-10YSZ) containing ions of La, Sr, and Mn was produced (Dispersion A-4).

Subsequently, 75.72 g of ammonium hydrogen carbonate (NH₄HCO₃) was dissolved in 3000 g of distilled water, whereby an aqueous solution of ammonium hydrogen carbonate (basic carbonate solution) was produced (Aqueous Solution B-4).

Then, Dispersion A-4 was dropped in Aqueous Solution B-4, whereby a neutralized precipitate was obtained. Here, aqueous ammonia of 25 mass % along with Dispersion A-4 was dropped in Aqueous Solution B-4 and the pH of Aqueous Solution B-4 was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated by the use of an electric furnace, whereby Composite Powder A-4 of La_{0.8}Sr_{0.2}MnO₃-yttria-stabilized zirconia (LSM-10YSZ) was obtained.

The masses of La, Sr, Mn, Y, and Zr in Composite Powder A-4 were measured by fluorescent X-ray analysis and the mass ratio of La_{0.8}Sr_{0.2}MnO₃ (LSM) and yttria-stabilized zirconia (YSZ) was calculated on the basis of the measurement result. As a result, the mass ratio (LSM:YSZ) was 50:50.

In order to evaluate the combination uniformity of Composite Powder A-4, crystallite diameters of LSM and YSZ of the composite powder were measured under two heating conditions of 6 hours at 600° C. and 6 hours at 800° C. The results are shown in Table 1.

Subsequently, 1.5 g of a mixture powder obtained by heating Composite Powder A-4 at 1000° C. for 6 hours was mixed with 0.5 g of polyethyleneglycol (with a molecular weight of 400) and 10 g of ethanol through the use of a ball mill, and the mixture solution was heated up to 80° C. to vaporize and remove ethanol, whereby Paste A-4 of La_{0.8}Sr_{0.2}MnO₃-yttria-stabilized zirconia (LSM-10YSZ) was obtained.

Then, 1.5 g of a nickel oxide (NiO) powder was mixed with 0.5 g of polyethyleneglycol (with a molecular weight of 400) and 10 g of ethanol through the use of a ball mill, and the mixture solution was heated up to 80° C. to vaporize and remove ethanol, whereby an NiO paste was produced.

Subsequently, the NiO paste was applied to an 8 mol % yttria-stabilized zirconia (8YSZ) substrate with a thickness of 300 μm through the use of a screen printing method and the resultant was then burned at 1200° C. for 2 hours, whereby a fuel electrode was formed on the 8YSZ substrate.

LSM-10YSZ Paste A-4 was applied to the surface of the 8YSZ substrate opposite to the surface on which the fuel electrode was formed through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the air electrode was measured by the use of the electrochemical characteristic tester shown in FIG. 1. Here, the electrode reaction resistance of the air electrode was evaluated by supplying dry air to the air electrode and the reference electrode and humidified hydrogen gas with a composition of 3% H₂O-97% H₂ to the fuel electrode at a flow rate of 50 mL/minute, and measuring the AC impedance between the reference electrode and the air electrode using the fuel electrode as a counter electrode. Two measurement temperatures of 700° C. and 800° C. were used and the measurement frequency was set to be in the range of 10 kHz to 0.1 Hz. The measurement results are shown in Table 1.

### Comparative Example 1

62.81 g of lanthanum nitrate (La(NO₃)₃6H₂O), 7.68 g of strontium nitrate (Sr(NO₃)₂), and 52.04 g of manganese nitrate (Mn(NO₃)₂6H₂O) were dissolved in 1000 g of diluted nitric acid with a pH of 2.0, whereby a metallic salt solution of La, Sr, and Mn was produced. The composition of oxide in the metallic salt solution was La_{0.8}Sr_{0.2}MnO₃.

Subsequently, 75.72 g of ammonium hydrogen carbonate (NH₄HCO₃) was dissolved in 3000 g of distilled water, whereby an aqueous solution of ammonium hydrogen carbonate (basic carbonate solution) was produced.

Then, the metallic salt solution of La, Sr, and Mn was dropped in the aqueous solution of ammonium hydrogen carbonate, whereby a neutralized precipitate was obtained. Here, an aqueous ammonia of 25 mass % along with the metallic salt solution of La, Sr, and Mn was dropped in the aqueous solution of ammonium hydrogen carbonate and the pH of the aqueous solution of ammonium hydrogen carbonate was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated at 800° C. for 6 hours by the use of an electric furnace, whereby Powder R-1 of La_{0.8}Sr_{0.2}MnO₃ (LSM) was obtained.

0.75 g of LSM powder R-1 and 0.75 g of 10 mol % yttria-stabilized zirconia (10YSZ) powder (made by TOSOH Corporation) were mixed with 0.5 g of polyethyleneglycol (with a molecular weight of 400) and 10 g of ethanol through the use of a ball mill, whereby a dispersion was obtained.

Subsequently, the mixture solution was heated up to 80° C. to vaporize and remove ethanol, whereby Paste R-1 of La_{0.8}Sr_{0.2}MnO₃-yttria-stabilized zirconia (LSM-10YSZ) was obtained.

In Comparative Example 1, the uniformity of combination of LSM powder R-1 and the 10YSZ powder is not evaluated. The reason is as follows. In this raw powder, LSM powder R-1 and the 10YSZ powder do not individually form composite powders and thus the uniformity of combination cannot be evaluated even when the crystallite diameter of the LSM is measured. In the dispersion containing the LSM powder and the 10YSZ powder, the dispersion average particle diameter of each component cannot be calculated.

Then, 1.5 g of a nickel oxide (NiO) powder was mixed with 0.5 g of polyethyleneglycol (with a molecular weight of 400) and 10 g of ethanol through the use of a ball mill, and the mixture solution was heated up to 80° C. to vaporize and remove ethanol, whereby an NiO paste was produced.

Subsequently, the NiO paste was applied to an 8 mol % yttria-stabilized zirconia (8YSZ) substrate with a thickness of 300 μm through the use of a screen printing method and the resultant was then burned at 1200° C. for 2 hours, whereby a fuel electrode was formed on the 8YSZ substrate.

LSM-10YSZ Paste R-1 was applied to the surface of the 8YSZ substrate opposite to the surface on which the fuel electrode was formed through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the air electrode was measured by the use of the electrochemical characteristic tester shown in FIG. 1. Here, the electrode reaction resistance of the air electrode was evaluated by supplying dry air to the air electrode and the reference electrode and humidified hydrogen gas with a composition of 3% H₂O-97% H₂ to the fuel electrode at a flow rate of 50 mL/minute, and measuring the AC impedance between the reference electrode and the air electrode using the fuel electrode as a counter electrode. Two measurement temperatures of 700° C. and 800° C. were used and the measurement frequency was set to the range of 10 kHz to 0.1 Hz. The measurement results are shown in Table 1.

### Comparative Example 2

62.81 g of lanthanum nitrate (La(NO₃)₃6H₂O), 7.68 g of strontium nitrate (Sr(NO₃)₂), 52.04 g of manganese nitrate (Mn(NO₃)₂6H₂O), 130.25 g of zirconium nitrate (Zr(NO₃)₄5H₂O), and 12.91 g of yttrium nitrate (Y(NO₃)₃6H₂O) were dissolved in 1000 g of diluted nitric acid with pH of 2.0, whereby a metallic salt solution of La, Sr, Mn, Zr, and Y was produced.

Here, the composition ratios of metal ions were set to La:Sr:Mn=0.8:0.2:1 and Zr:Y=0.9:0.1 so that oxides produced from the raw material are La_{0.8}Sr_{0.2}MnO₃ and 10 mol % yttria-stabilized zirconia.

Subsequently, 75.72 g of ammonium hydrogen carbonate (NH₄HCO₃) was dissolved in 3000 g of distilled water, whereby an aqueous solution of ammonium hydrogen carbonate (basic carbonate solution) was produced.

Then, the metallic salt solution of La, Sr, Mn, Zr, and Y was dropped in the aqueous solution of ammonium hydrogen carbonate, whereby a neutralized precipitate was obtained. Here, an aqueous ammonia of 25 mass % along with the metallic salt solution of La, Sr, and Mn was dropped in the aqueous solution of ammonium hydrogen carbonate and the pH of the aqueous solution of ammonium hydrogen carbonate was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated by the use of an electric furnace, whereby Composite Powder R-2 of La_{0.8}Sr_{0.2}MnO₃-yttria-stabilized zirconia (LSM-10YSZ) was obtained.

The masses of La, Sr, Mn, Y, and Zr in Composite Powder R-2 were measured by fluorescent X-ray analysis and the mass ratio of La_{0.8}Sr_{0.2}MnO₃ (LSM) and yttria-stabilized zirconia (YSZ) was calculated on the basis of the measurement result. As a result, the mass ratio (LSM:YSZ) was 50:50.

In order to evaluate the combination uniformity of Composite Powder R-2, crystallite diameters of LSM and YSZ of the composite powder were measured under two heating conditions of 6 hours at 600° C. and 6 hours at 800° C. The results are shown in Table 1.

Subsequently, 1.5 g of a mixture powder obtained by heating Composite Powder R-2 at 1000° C. for 6 hours was mixed with 0.5 g of polyethyleneglycol (with a molecular weight of 400) and 10 g of ethanol through the use of a ball mill, and the mixture solution was heated up to 80° C. to vaporize and remove ethanol, whereby Paste R-2 of La_{0.8}Sr_{0.2}MnO₃-yttria-stabilized zirconia (LSM-10YSZ) was obtained.

Then, 1.5 g of a nickel oxide (NiO) powder was mixed with 0.5 g of polyethyleneglycol (with a molecular weight of 400) and 10 g of ethanol through the use of a ball mill, and the mixture solution was heated up to 80° C. to vaporize and remove ethanol, whereby an NiO paste was produced.

Subsequently, the NiO paste was applied to a 8 mol % yttria-stabilized zirconia (8YSZ) substrate with a thickness of 300 μm through the use of a screen printing method and the resultant was then burned at 1200° C. for 2 hours, whereby a fuel electrode was formed on the 8YSZ substrate.

LSM-10YSZ Paste R-2 was applied to the surface of the 8YSZ substrate opposite to the surface on which the fuel electrode was formed through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the air electrode was measured by the use of the electrochemical characteristic tester shown in FIG. 1. Here, the electrode reaction resistance of the air electrode was evaluated by supplying dry air to the air electrode and the reference electrode and humidified hydrogen gas with a composition of 3% H₂O-97% H₂ to the fuel electrode at a flow rate of 50 mL/minute, and measuring the AC impedance between the reference electrode and the air electrode using the fuel electrode as a counter electrode. Two measurement temperatures of 700° C. and 800° C. were used and the measurement frequency was set to the range of 10 kHz to 0.1 Hz. The measurement results are shown in Table 1.

TABLE 1

| | | | | | | | electrode reaction | |
|---|---|---|---|---|---|---|---|---|
| | | | crystallite diameter (nm) | | | | resistance | |
| | mass ratio | | 600° C. | | 800° C. | | (Ω · cm²) | |
| | LSM | YSZ | LSM | YSZ | LSM | YSZ | 700° C. | 800° C. |
| Ex. 1 | 50 | 50 | *1 | 3 | 13 | 5.3 | 1.29 | 0.2 |
| Ex. 2 | 70 | 30 | *1 | 2.5 | 13.5 | 2.9 | 2.61 | 0.59 |
| Ex. 3 | 30 | 70 | *1 | 5.1 | 10.1 | 5.1 | 3.86 | 1.04 |
| Ex. 4 | 50 | 50 | *1 | 4.3 | 15.7 | 8.2 | 2.15 | 0.72 |
| Com. | 50 | 50 | — | — | — | — | 7.12 | 1.61 |
| Ex. 1 | | | | | | | | |
| Com. | 50 | 50 | *1 | 12 | 13 | 51 | 12.15 | 3.71 |
| Ex. 2 | | | | | | | | |

(Note)
*1: Unmeasurable (LSM is not crystallized)

In Examples 1 to 4, since the composite ceramic powder was produced by heating the neutralized precipitate obtained by adding the zirconia acidic dispersion containing the zirconia (10YSZ) particles formed of 10 mol % yttria-stabilized zirconia and the ions of La, Sr, and Mn for forming the La_{0.8}Sr_{0.2}MnO₃ (LSM) particles to the alkali solution, the electrode reaction resistance in the solid-oxide fuel cell formed using the composite particles was lower than that in the related art (comparative examples) and exhibited excellent characteristics.

Particularly, in that the dispersion average particle diameter of the 10YSZ particles as a raw material is equal to or less than 20 nm, the crystallite diameter of the produced LSM particles was about 15 nm and the crystallite diameter of the 10YSZ particles was about 5 nm, both of which are nanometer levels. The electrode reaction resistance in the solid-oxide fuel cell formed using the composite particles was very low and exhibited excellent characteristics.

On the other hand, in Comparative Example 1, the electrode reaction resistance was high and did not exhibit excellent characteristics. The reason is thought to be as follows. Since the mixture of the 10YSZ particles and the LSM particles was used as the raw material, the primary particles thereof aggregated and thus the 10YSZ particles and the LSM particles in the resultant composite ceramic powder were non-uniformly mixed.

In Comparative Example 2, in spite of the small size of the particles in the composite ceramic powder, the electrode reaction resistance was high but excellent characteristics were not obtained. The reason is thought to be as follows. Since the neutralized precipitate was obtained in the state where metal ions of La, Sr, Mn, Zr, and Y coexist, products other than the 10YSZ particles and the LSM particles, for example, impurities such as LaZrO₂ causing an increase in electrode reaction resistance, were produced in the product after the heat treatment at 1000° C., thereby causing the deterioration in characteristics.

### Example 5

A nickel nitrate solution in which 30.82 g of nickel nitrate hexahydrate (Ni(NO₃)₂6H₂O) is dissolved in 650 g of diluted nitric acid with a pH of 3.3 was added to 50 g of 10 mol % yttria-stabilized zirconia (10YSZ) dispersion (with a solid concentration of 10YSZ of 8.4 mass % and a pH of 4.6) with a dispersion average particle diameter of 7.5 nm and the resultant solution was agitated, whereby an acidic dispersion (with a pH of 3.95) of 10 mol % yttria-stabilized zirconia (Ni-10YSZ) containing nickel ions was produced (Dispersion A-5).

Subsequently, 4.19 g of ammonium hydrogen carbonate (NH₄HCO₃) was dissolved in 133 g of distilled water, whereby an aqueous solution of ammonium hydrogen carbonate (basic carbonate solution) was produced (Aqueous Solution B-5).

Then, Dispersion A-5 was dropped in Aqueous Solution B-5, whereby a neutralized precipitate was obtained. Here, aqueous ammonia of 25 mass % along with Dispersion A-5 was dropped in Aqueous Solution B-5 and the pH of Aqueous Solution B-5 was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated by the use of an electric furnace, whereby Composite Powder A-5 of nickel oxide-yttria-stabilized zirconia (NiO-YSZ) was obtained.

The masses of Ni, Y, and Zr in Composite Powder A-5 were measured by fluorescent X-ray analysis and the mass ratio of nickel oxide (NiO) and yttria-stabilized zirconia (YSZ) was calculated on the basis of the measurement result. Accordingly, the mass ratio (NiO:YSZ) was 65:35.

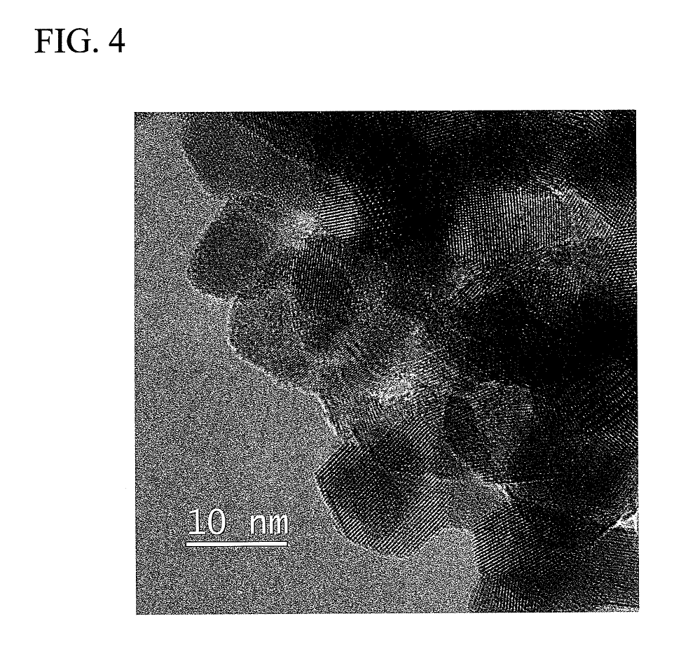

FIG. 4 shows a transmission electron microscopy (TEM) image of Composite Powder A-5.

It can be seen from the drawing that the yttria-stabilized zirconia particles are combined into the nickel oxide particles in a body.

In order to evaluate the combination uniformity of Composite Powder A-5, crystallite diameters of nickel oxide and yttria-stabilized zirconia of the composite powder were measured under two heating conditions of 6 hours at 600° C. and 6 hours at 800° C. The results are shown in Table 2.

Subsequently, 1.5 g of a mixture powder obtained by heating Composite Powder A-5 at 1000° C. for 6 hours was mixed with 0.5 g of polyethyleneglycol (with a molecular weight of 400) and 10 g of ethanol through the use of a ball mill, and the mixture solution was heated up to 80° C. to vaporize and remove ethanol, whereby nickel oxide-yttria-stabilized zirconia was produced. Then, this paste was applied to an 8 mol % yttria-stabilized zirconia (8YSZ) substrate with a thickness of 300 μm through the use of a screen printing method and the resultant was then burned at 1300° C. for 2 hours, whereby a fuel electrode was formed on the 8YSZ substrate.

Then, 1.5 g of an La_{0.8}Sr_{0.2}MnO₃ (LSM) powder was mixed with 0.5 g of polyethyleneglycol (with a molecular weight of 400) and 10 g of ethanol through the use of a ball mill, and the mixture solution was heated up to 80° C. to vaporize and remove ethanol, whereby an LSM paste was produced. The LSM Paste was applied to the surface of the 8YSZ substrate opposite to the surface on which the fuel electrode was formed through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the fuel electrode was measured by the use of the electrochemical characteristic tester shown in FIG. 1. Here, the electrode reaction resistance of the fuel electrode was evaluated by supplying dry air to the air electrode and the reference electrode and humidified hydrogen gas with a composition of 3% H₂O-97% H₂ to the fuel electrode at a flow rate of 50 mL/minute, and measuring the AC impedance between the reference electrode and the fuel electrode using the air electrode as a counter electrode. Two measurement temperatures of 600° C. and 800° C. were used and the measurement frequency was set to the range of 10 kHz to 0.1 Hz. The measurement results are shown in Table 2.

The surface of the fuel electrode was analyzed using TEM-EDX. As a result, composite particles in which Ni, Y, and Zr are uniformly distributed with a high density were confirmed.

### Example 6

A nickel nitrate solution, in which 13.50 g of nickel nitrate hexahydrate (Ni(NO₃)₂6H₂O) is dissolved in 650 g of diluted nitric acid with a pH of 3.3 was added to 50 g of 10 mol % yttria-stabilized zirconia (10YSZ) dispersion (with a solid concentration of 10YSZ of 8.4 mass % and a pH of 4.6) with a dispersion average particle diameter of 7.5 nm and the resultant solution was agitated, whereby an acidic dispersion (with pH of 3.95) of 10 mol % yttria-stabilized zirconia (Ni-10YSZ) containing nickel ions, was produced (Dispersion A-6).

Subsequently, similarly to Example 5, 4.19 g of ammonium hydrogen carbonate (NH₄HCO₃) was dissolved in 133 g of distilled water, whereby an aqueous solution of ammonium hydrogen carbonate (basic carbonate solution) was produced (Aqueous Solution B-5).

Then, Dispersion A-6 was dropped in Aqueous Solution B-5, whereby a neutralized precipitate was obtained. Here, aqueous ammonia of 25 mass % along with Dispersion A-6 was dropped in Aqueous Solution B-5 and the pH of Aqueous Solution B-5 was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated by the use of an electric furnace, whereby Composite Powder A-6 of nickel oxide-yttria-stabilized zirconia was obtained.

The masses of Ni, Y, and Zr in Composite Powder A-6 were measured by fluorescent X-ray analysis and the mass ratio of nickel oxide (NiO) and yttria-stabilized zirconia (YSZ) was calculated on the basis of the measurement result. As a result, the mass ratio (NiO:YSZ) was 45:55.

In order to evaluate the combination uniformity of Composite Powder A-6, crystallite diameters of nickel oxide and yttria-stabilized zirconia of the composite powder were measured under two heating conditions of 6 hours at 600° C. and 6 hours at 800° C. The results are shown in Table 2.

Subsequently, 1.5 g of a mixture powder obtained by heating Composite Powder A-6 at 1000° C. for 6 hours was mixed with 0.5 g of polyethyleneglycol (with a molecular weight of 400) and 10 g of ethanol through the use of a ball mill, and the mixture solution was heated up to 80° C. to vaporize and remove ethanol, whereby nickel oxide-yttria-stabilized zirconia was produced. Then, this paste was applied to an 8 mol % yttria-stabilized zirconia (8YSZ) substrate with a thickness of 300 μm through the use of a screen printing method and the resultant was then burned at 1300° C. for 2 hours, whereby a fuel electrode was formed on the 8YSZ substrate.

Then, 1.5 g of an La_{0.8}Sr_{0.2}MnO₃ (LSM) powder was mixed with 0.5 g of polyethyleneglycol (with a molecular weight of 400) and 10 g of ethanol through the use of a ball mill, and the mixture solution was heated up to 80° C. to vaporize and remove ethanol, whereby an LSM paste was produced. The LSM Paste was applied to an 8 mol % yttria-stabilized zirconia (8YSZ) substrate through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the fuel electrode was measured by the use of the electrochemical characteristic tester shown in FIG. 1. Here, the electrode reaction resistance of the fuel electrode was evaluated by supplying the dry air to the air electrode and the reference electrode and the humidified hydrogen gas with a composition of 3% H₂O-97% H₂ to the fuel electrode at a flow rate of 50 mL/minute, and measuring the AC impedance between the reference electrode and the fuel electrode using the air electrode as a counter electrode. Two measurement temperatures of 600° C. and 800° C. were used and the measurement frequency was set to the range of 10 kHz to 0.1 Hz. The measurement result is shown in Table 2.

The surface of the fuel electrode was analyzed using TEM-EDX. As a result, composite particles in which Ni, Y, and Zr are uniformly distributed with a high density were confirmed.

### Example 7

A nickel nitrate solution in which 75.00 g of nickel nitrate hexahydrate (Ni(NO₃)₂6H₂O) is dissolved in 650 g of diluted nitric acid with pH of 3.3 was added to 50 g of 10 mol % yttria-stabilized zirconia (10YSZ) dispersion (with a solid concentration of 10YSZ of 8.4 mass % and pH of 4.6) with a dispersion average particle diameter of 7.5 nm and the resultant solution was agitated, whereby an acidic dispersion (with a pH of 3.95) of 10 mol % yttria-stabilized zirconia (Ni-10YSZ) containing nickel ions was produced (Dispersion A-7).

Subsequently, similarly to Example 5, 4.19 g of ammonium hydrogen carbonate (NH₄HCO₃) was dissolved in 133 g of distilled water, whereby an aqueous solution of ammonium hydrogen carbonate (basic carbonate solution) was produced (Aqueous Solution B-5).

Then, Dispersion A-7 was dropped in Aqueous Solution B-5, whereby a neutralized precipitate was obtained. Here, aqueous ammonia of 25 mass % along with Dispersion A-7 was dropped in Aqueous Solution B-5 and pH of Aqueous Solution B-5 was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated by the use of an electric furnace, whereby Composite Powder A-7 of nickel oxide-yttria-stabilized zirconia (NiO-YSZ) was obtained.

The masses of Ni, Y, and Zr in Composite Powder A-7 were measured by fluorescent X-ray analysis and the mass ratio of nickel oxide (NiO) and yttria-stabilized zirconia (YSZ) was calculated on the basis of the measurement result. As a result, the mass ratio (NiO:YSZ) was 82:18.

In order to evaluate the combination uniformity of Composite Powder A-7, crystallite diameters of nickel oxide and yttria-stabilized zirconia of the composite powder were measured under two heating conditions of 6 hours at 600° C. and 6 hours at 800° C. The results are shown in Table 2.

Subsequently, 1.5 g of a mixture powder obtained by heating Composite Powder A-7 at 1000° C. for 6 hours was mixed with 0.5 g of polyethyleneglycol (with a molecular weight of 400) and 10 g of ethanol through the use of a ball mill, and the mixture solution was heated up to 80° C. to vaporize and remove ethanol, whereby nickel oxide-yttria-stabilized zirconia was produced. Then, this paste was applied to an 8 mol % yttria-stabilized zirconia (8YSZ) substrate with a thickness of 300 μm through the use of a screen printing method and the resultant was then burned at 1300° C. for 2 hours, whereby a fuel electrode was formed on the 8YSZ substrate.

Then, 1.5 g of an La_{0.8}Sr_{0.2}MnO₃ (LSM) powder was mixed with 0.5 g of polyethyleneglycol (with a molecular weight of 400) and 10 g of ethanol through the use of a ball mill, and the mixture solution was heated up to 80° C. to vaporize and remove ethanol, whereby an LSM paste was produced. The LSM Paste was applied to an 8 mol % yttria-stabilized zirconia (8YSZ) substrate through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the fuel electrode was measured by the use of the electrochemical characteristic tester shown in FIG. 1. Here, the electrode reaction resistance of the fuel electrode was evaluated by supplying the dry air to the air electrode and the reference electrode and the humidified hydrogen gas with a composition of 3% H₂O-97% H₂ to the fuel electrode at a flow rate of 50 mL/minute, and measuring the AC impedance between the reference electrode and the fuel electrode using the air electrode as a counter electrode. Two measurement temperatures of 600° C. and 800° C. were used and the measurement frequency was set to the range of 10 kHz to 0.1 Hz. The measurement result is shown in Table 2.

The surface of the fuel electrode was analyzed using TEM-EDX. As a result, composite particles in which Ni, Y, and Zr are uniformly distributed with a high density were confirmed.

### Comparative Example 3

8.4 g of a 10 mol % yttria-stabilized zirconia powder TZ-10Y (made by TOSOH Corporation) was added to 41.6 g of diluted nitric acid with a pH of 3.3 and the resultant solution was dispersed by the use of an ultrasonic homogenizer, whereby a dispersion was produced. The dispersion average particle diameter of the yttria-stabilized zirconia powder in the dispersion was 120 nm.

Subsequently, a nickel nitrate solution in which 30.82 g of nickel nitrate hexahydrate (Ni(NO₃)₂6H₂O) is dissolved in 650 g of diluted nitric acid with pH of 3.3 was added to the dispersion and the resultant solution was agitated, whereby an acidic dispersion (with pH of 3.95) of 10 mol % yttria-stabilized zirconia (Ni-10YSZ) containing nickel ions was produced (Dispersion A-8).

Subsequently, similarly to Example 5, 4.19 g of ammonium hydrogen carbonate (NH₄HCO₃) was dissolved in 133 g of distilled water, whereby an aqueous solution of ammonium hydrogen carbonate (basic carbonate solution) was produced (Aqueous Solution B-5).

Then, Dispersion A-8 was dropped in Aqueous Solution B-5, whereby a neutralized precipitate was obtained. Here, aqueous ammonia of 25 mass % along with Dispersion A-8 was dropped in Aqueous Solution B-5 and the pH of Aqueous Solution B-5 was kept at 8.

Subsequently, the resultant neutralized precipitate was washed with water four times through the use of a suction filtration and burning device to remove impurity ions, the solvent was then replaced with ethanol, and the resultant was dried at 80° C. in a drier for 24 hours. The resultant dried product was pulverized by the use of a mortar and heated by the use of an electric furnace, whereby Composite Powder A-8 of nickel oxide-yttria-stabilized zirconia (NiO-YSZ) was obtained.

The masses of Ni, Y, and Zr in Composite Powder A-8 were measured by fluorescent X-ray analysis and the mass ratio of nickel oxide (NiO) and yttria-stabilized zirconia (YSZ) was calculated on the basis of the measurement result. As a result, the mass ratio (NiO:YSZ) was 65:35.

In order to evaluate the combination uniformity of Composite Powder A-8, crystallite diameters of nickel oxide and yttria-stabilized zirconia of the composite powder were measured under two heating conditions of 6 hours at 600° C. and 6 hours at 800° C. The results are shown in Table 2.

Subsequently, 1.5 g of a mixture powder obtained by heating Composite Powder A-8 at 1000° C. for 6 hours was mixed with 0.5 g of polyethyleneglycol (with a molecular weight of 400) and 10 g of ethanol through the use of a ball mill, and the mixture solution was heated up to 80° C. to vaporize and remove ethanol, whereby nickel oxide-yttria-stabilized zirconia was produced. Then, this paste was applied to an 8 mol % yttria-stabilized zirconia (8YSZ) substrate with a thickness of 300 μm through the use of a screen printing method and the resultant was then burned at 1300° C. for 2 hours, whereby a fuel electrode was formed on the 8YSZ substrate.

Then, 1.5 g of an La_{0.8}Sr_{0.2}MnO₃ (LSM) powder was mixed with 0.5 g of polyethyleneglycol (with a molecular weight of 400) and 10 g of ethanol through the use of a ball mill, and the mixture solution was heated up to 80° C. to vaporize and remove ethanol, whereby an LSM paste was produced. The LSM Paste was applied to an 8 mol % yttria-stabilized zirconia (8YSZ) substrate through the use of the screen printing method and the resultant was then burned at 1100° C. for 2 hours, whereby an air electrode was formed on the 8YSZ substrate. A platinum wire was wound on the side surface of the 8YSZ substrate to form a reference electrode.

The electrode reaction resistance of the fuel electrode was measured by the use of the electrochemical characteristic tester shown in FIG. 1. Here, the electrode reaction resistance of the fuel electrode was evaluated by supplying dry air to the air electrode and the reference electrode and humidified hydrogen gas with a composition of 3% H₂O-97% H₂ to the fuel electrode at a flow rate of 50 mL/minute, and measuring the AC impedance between the reference electrode and the fuel electrode using the air electrode as a counter electrode. Two measurement temperatures of 600° C. and 800° C. were used and the measurement frequency was set to the range of 10 kHz to 0.1 Hz. The measurement results are shown in Table 2.

TABLE 2

| | dispersion | | crystallite diameter | | | | | |
|---|---|---|---|---|---|---|---|---|
| | average | | of mixture powder | | | | | |
| | particle | | after heat treatment | | | | electrode reaction | |
| | diameter of | | (nm) | | | | resistance | |
| | YSZ in dispersion | NiO:YSZ | 600° C. | | 800° C. | | (Ω · cm²) | |
| | (nm) | (mass ratio) | NiO | YSZ | NiO | YSZ | 600° C. | 800° C. |
| Ex. 5 | 7.5 | 65:35 | 6.1 | 3.5 | 11.2 | 9.8 | 4.07 | 0.21 |
| Ex. 6 | 7.5 | 45:55 | 3.9 | 3.6 | 9.7 | 9.4 | 1.44 | 0.15 |
| Ex. 7 | 7.5 | 82:18 | 9.0 | 3.3 | 13.2 | 8.5 | 41.8 | 0.87 |
| Com. | 120 | 65:35 | 160 | 75 | 160 | 75 | 26.8 | 1.38 |
| Ex. 3 | | | | | | | | |

### INDUSTRIAL APPLICABILITY

The composite ceramic powder according to the first embodiment of the invention is a composite ceramic powder containing perovskite type oxide and zirconia, which is excellent in uniform distribution at a nanometer level and composition controllability of plural types of oxide particles, which has a lot of three-phase interfaces, and which is excellent in generation of oxygen ions, by adding the zirconia acidic dispersion containing zirconia particles formed of yttria-stabilized zirconia and ions of one or two or more elements selected from the group consisting of elements A, B, C, and D included in A₁₋ₓBₓC_{1-y}D_{y}O₃ (where A represents one or two elements selected from the group consisting of La and Sm; B represents one or two or more elements selected from the group consisting of Sr, Ca, and B; C represents one or two elements selected from the group consisting of Co and Mn; D represents one or two elements selected from the group consisting of Fe and Ni; and x and y satisfy 0.1≦x≦0.5 and 0≦y≦0.3, respectively) to an alkali solution to produce a neutralized precipitate and heating the produced neutralized precipitate. Accordingly, the composite ceramic powder can be suitably applied to the field of solid-oxide fuel cells and various fields relating thereto.

The composite ceramic powder according to the second embodiment of the invention is a composite ceramic powder containing nickel oxide and zirconia, which is excellent in uniform distribution and composition controllability of plural types of oxide particles, which has a lot of three-phase interfaces, and which is excellent in electron conductivity, by adding the zirconia acidic dispersion containing zirconia particles formed of yttria-stabilized zirconia and nickel ions to an alkali solution to produce a neutralized precipitate and heating the produced neutralized precipitate. Accordingly, the composite ceramic powder can be suitably applied to the field of solid-oxide fuel cells and various fields relating thereto.

### REFERENCE SIGNS LIST

1: ELECTROLYTE
2: REFERENCE ELECTRODE
3: AIR ELECTRODE
4: FUEL ELECTRODE
5: PLATINUM MESH
6: GLASS SEAL
7, 8: ALUMINA TUBE
9: PLATINUM WIRE
10: DRY AIR
11: HUMIDIFIED HYDROGEN GAS

1. A composite ceramic powder comprising:
oxide expressed by A₁₋ₓBₓC_{1-y}D_{y}O₃ or nickel oxide, and
zirconia,
wherein A represents one or two elements selected from the group consisting of La and Sm; B represents one or two or more elements selected from the group consisting of Sr, Ca, and Ba; C represents one or two elements selected from the group consisting of Co and Mn; D represents one or two elements selected from the group consisting of Fe and Ni; and x and y satisfy 0.1≦x≦0.5 and 0≦y≦0.3, and
the composite ceramic powder is produced by heating a neutralized precipitate which is obtained by adding a zirconia acidic dispersion to an alkali solution, wherein the zirconia acidic dispersion comprises
zirconia particles formed of yttria-stabilized zirconia and
nickel ions or ions of one or two or more elements selected from the group consisting of elements A, B, C, and D included in A₁₋ₓBₓC_{1-y}D_{y}O₃.

2. The composite ceramic powder according to claim 1, wherein a dispersion average particle diameter of the zirconia particles in the zirconia acidic dispersion is equal to or less than 20 nm.

3. A process of producing a composite ceramic powder comprising
oxide expressed by A₁₋ₓBₓC_{1-y}D_{y}O₃ or nickel oxide, and
zirconia,
wherein A represents one or two elements selected from the group consisting of La and Sm; B represents one or two or more elements selected from the group consisting of Sr, Ca, and Ba; C represents one or two elements selected from the group consisting of Co and Mn; D represents one or two elements selected from the group consisting of Fe and Ni; and x and y satisfy 0.1≦x≦0.5 and 0≦y≦0.3,
the process comprises steps of
producing a neutralized precipitate by adding a zirconia acidic dispersion to an alkali solution,
wherein the zirconia acidic dispersion comprises
zirconia particles formed of yttria-stabilized zirconia and
nickel ions or ions of one or two or more elements selected from the group consisting of elements A, B, C, and D included in A₁₋ₓBₓC_{1-y}D_{y}O₃, and
heating the neutralized precipitate at a temperature equal to or higher than 200° C.

4. The process according to claim 3, wherein a dispersion average particle diameter of the zirconia particles in the zirconia acidic dispersion is equal to or less than 20 nm.

5. The process according to claim 3, wherein a ratio (M:Z) of the percentage by mass (M) of the nickel ions or the ions of the one or two or more elements selected from the group consisting of elements A, B, C, and D in the zirconia acidic dispersion in terms of oxide and the percentage by mass (Z) of the zirconia particles is in the range of M:Z=90:10 to 10:90.

6. A solid-oxide fuel cell comprising the composite ceramic powder according to claim 1 as an electrode material.

7. A solid-oxide fuel cell, comprising the composite ceramic powder which comprises
the oxide expressed by A₁₋ₓBₓC_{1-y}D_{y}O₃ and zirconia according to claim 1 as a material of an air electrode and
the composite ceramic powder containing nickel oxide and zirconia according to claim 1 as a material of a fuel electrode.
